(19) United States
(12) Patent Application Publication
(10) Pub. No.: US 2015/0045527 A1
(43) Pub. Date: Feb. 12, 2015

(54) Film, especially for use in non-disruptive sewage pipe renovation

(71) Applicant: Buergofol GmbH, Siegenburg (DE)

(72) Inventors: Franz Schleicher, Ingolstadt (DE); Abdel-Kader Boutrid, Siegenburg (DE); Kurt Stark, Neuhaus a.d. Pegnitz (DE)

(21) Appl. No.: 14/456,398

(22) Filed: Aug. 11, 2014

(30) Foreign Application Priority Data
Aug. 9, 2013 (DE) 10 2013 108 680.2

(51) Int. Cl. C08J 5/18; F16L 55/165

(52) U.S. Cl. CPC C08J 5/18; F16L 55/1656; C08J 2323/06
USPC 526/352.2

(57) ABSTRACT

A film suitable for permanent, firm bonding with resin after hardening of the resin is provided with at least one layer containing at least one polyolefin plastomer (POP) or one polyolefin elastomer (POE) capable of bringing about a permanent, direct adhesion of the resin to this layer during the course of resin hardening. The invention likewise refers to an arrangement with at least one such film and a resin on one side of the film. The invention also refers to a tube liner for non-disruptive sewage pipe renovation and various applications of the film according to the invention or the arrangement according to the invention in non-disruptive sewage pipe renovation.

### FIELD OF THE INVENTION

The invention refers to a film, especially for use in non-disruptive sewage pipe renovation that employs a pipe lining process.

### BACKGROUND

The areas of application for films keep expanding. Among the areas of application is also the pipe lining process for non-disruptive sewage pipe renovation, in which a tube liner (also known as insertion tube or simply a liner) is used in the glass fiber-tube liner system with UV or steam curing, typically an inner and outer tube, and a resin-absorbent carrier material (e.g. glass fiber fabric, fleece, textile material) impregnated with reactive plastic resin is inserted between them. Examples of reactive plastic resin are commercially available UP resins (polyester and unsaturated polyester resins), VE resins (vinyl ester resins) or EP resins (epoxy resins). In the case of UP or VE resins, their curing is done with the help of photoinitiators, for example, but curing can also be accomplished with heat.

Once inside the pipe, the insertion tube or tube liner is inflated until it makes tight contact with an external wall in order to subsequently cure the resin with UV light from a UV source being pulled slowly through the pipe, for example. Finally, the inner film of the insertion liner is pulled off and removed. The layer with the carrier material is then exposed to the substances to be guided through the pipe.

### SUMMARY OF THE INVENTION

It is a task of this invention to make a film available that will especially facilitate the pipe lining process. Such a film should, whenever possible, also be used in other fields. Additional objects and advantages of the invention will be set forth in part in the following description, or may be obvious from the description, or may be learned through practice of the invention.

The film according to the invention is executed for the permanent application of resin by making a permanent bond with the resin possible. To accomplish this, it has at least one layer that contains at least one polyolefin plastomer (POP) or one polyolefin elastomer (POE). As a result of this, the resin can adhere directly (i.e. immediately) to the film during the course of its hardening or afterwards. It has been surprisingly found out that by using such a film in non-disruptive sewage pipe renovation, it is possible to dispense completely with the non-woven (such as a fleece) typically used for bonding the film with resin, which is then mounted on the film. Thus, the resin—with the impregnated carrier material (e.g. glass fiber fabric), which is absolutely required for the pipe lining process owing to the toughness after resin curing—can now be brought directly into contact with the film according to the invention. Thus, after the resin has hardened, a firm bond of film and resin (including carrier material) can be attained. Therefore, it is possible to dispense with a resin-absorbent material on the film, especially fleece, that is previously mounted on the film and this saves time and lowers costs. In addition, there are no longer problems with the bonding of the (no longer existing) fleece with the film.

Contrary to the state of the art, the resin therefore according to the invention bonds directly and permanently to the layer of the film according to the invention. The film no longer has to be previously mounted or bonded with a resin-absorbent material—as is the case according to the state of the art—such as fleece, for example, in order to attain resin bonding. Although the film can advantageously bond as well with the carrier material as such, which is impregnated with resin, the general bonding of the film directly with the resin is the essential feature of this invention. Thus, the film according to the invention would also bond to pure resin, as shown in the following examples.

Polyolefin plastomers (POP) and polyolefin elastomers (POE) are special forms of polyolefins, and this differentiates these product classes from the usual polyolefins.

The polyolefin plastomers (POP) and polyolefin elastomers (POE) used in layers for resin adhesion according to the invention are essentially linear low-density polyethylenes with very low molecular weight (LLDPE-VLMW), i.e. they have a low molecular weigh distribution of around 2.0. They were originally developed to improve the elastic properties of packaging films. In the meantime, these elastic polyethylenes are also used for less demanding injection molding applications to replace rubber economically. POP and POE are also used in foamed products.

A plastomer is a polymer material that combines the properties of elastomers and plastics, for example rubbery properties with plastic processability.

Polyolefin plastomers are made up of ethylene and additional alpha-olefin components. They differ from other homogeneous polymers in that they have long chain branches (LCB) to improve processability. Generally, they have a low molecular weight distribution of about 2.0 and typically a density lower than 0.910 g/cm³. They can be manufactured with single site catalysts (also known from time to time as constrained geometry catalysts or Ziegler-Natta catalysts. Polyolefin plastomers (POPs) and polyolefin elastomers (POEs) are understood to be especially metallocen catalyzed polymers having the properties mentioned above.

Typically, POP and POE are copolymers made from ethylene and octane or ethylene and hexene, or ethylene and butene, or ethylene and propylene. In particular, many of the polyolefin plastomers being used today are essentially linear ethylene-octene copolymers. Polyolefin plastomers can be transparent or opaque and are generally suitable for applications needing high flexibility, softness or toughness.

For example, the Dow Chemical Company offers polyolefin plastomers under the brand name AFFINITY, polyolefin elastomers under the brand name Affinity GA and ENGAGE, and plastomers and elastomers under the brand name VERSIFY. These products are manufactured with Dow's INSITE® technology, which employs the special metallocen catalysts.

One method to differentiate polyolefin plastomers from other polymers (except for determining density, see above) can be implemented with the dart drop method, measured according to ASTM D 1709/ISO 7765-1. This process determines the differences of significantly different degrees of brittleness or dynamic puncture resistance. In this case, a weight (dart) is dropped from a defined height to a wrinkle-free and firmly clamped film. If the weight does not puncture the film, the next heaviest weight is selected. In a test series of 20-25 drop tests, the one weight is determined by puncturing the film in 50% of the drop tests, and barely not puncturing in the other half.

The two different methods implemented are known as Method A and Method B. They differ in the size and the dropping height of the weight. In Method A, the weight has a diameter of 38 mm and a drop height of 0.66 m is selected. In Method B, the diameter of the weight is 51 mm and the drop height 1.5 m.

For example, the following AFFINITY products (POP) made by the Dow Chemical Group show the following properties (the measuring standards D1238, D792 and D1709 are also indicated):

| | melt index | density | film | dart impact (g) |
|---|---|---|---|---|
| | (g/10 min) | (g/cm³) | thickness | D1709 |
| | D1238 | D792 | (μm) | Method B |
| AFFINITY PF 1140 | 1.6 | 0.897 | 51 | >850 |
| AFFINITY PL 1840 | 1.0 | 0.909 | 51 | >830 |
| AFFINITY PL 1850 | 3.0 | 0.902 | 20 | >830 |
| AFFINITY PL 1880 | 1.0 | 0.902 | 51 | >830 |
| AFFINITY PL 1881 | 1.0 | 0.904 | 51 | >830 |

The POP in the layer containing POP of the film according to the invention complies preferably with at least one of the above criteria, advantageously with all of them, i.e. a melt index of 1.0 to 3.0 g/10 min—or more broadly stated between 0.5 and 4 g/10 min—according to D1238, a density between 0.897 and 0.904 g/cm³ according to D792 and a dart impact (Method B according to D1709) of more than 830 g. POP compounds having values slightly above or below them are preferably included too.

Various manufacturers offer different polyolefin plastomers. The Borealis Co., for example, sells under the Exact® brand name various polyolefin plastomers in form o alpha-olefin copolymers manufactured with the help of metallocen catalysts. A new series of Exact® plastomers uses ethylene-butene (EB) as comonomer.

Polyolefin elastomers (POE) are likewise also obtained by means of metallocen catalysts, preferably through the above-mentioned single site or constrained geometry catalysts. They are copolymers made from ethylene and another alpha olefin such as butene or octene, for example. The metallocen catalyst polymerizes the ethylene and comonomer sequences selectively (see the above-mentioned polyolefin elastomers made by the Dow Chemical Company, manufactured by means of INSITE® technology). An increase in the number of comonomers results in polymers with higher elasticity because the incorporation of comonomers interrupts polyethylene crystallinity. Most commercially available POEs are copolymers made either from ethylene butene or ethylene octene.

For example, the ENGAGE polyolefin elastomers (ethylene octane copolymers: 8842, 8180, 8130, 8137, 5150, 8157, 8100, 8107, 8200, 8207, 8400, 8407, 8452, 8411, 8003, 8401, 8440, 8480, 8450, 8402, 8540; ethylene butene copolymers: 7467, 7447, 7270, 7277, 7256) from the Dow Chemical Company have the following properties:
Molecular weight distribution, MWD: narrow to moderate
Melting index at 190° C.: <0.5 to 30 g/10 min
Density: 0.857 to 0.910 g/cm³
Glass transition temperature: −61 to −35° C.
Melting range: 36 to 103° C.
Shore A hardness: 56 to 96
Flexural modulus: 3 to 110 MPa

A POE in the POE-containing layer of the film according to the invention complies preferably with at least one of the previous criteria, more preferably with some and ideally with all.

The film according to the invention can be used in various areas of non-disruptive sewage pipe renovation. The possible areas of application are both the inversion of the pipe liner and its drawing-in, as well as the thermal and UV curing of the tube liner's resin (with fleece-free films). Accordingly, the invention also comprises a tube liner with at least one film according to the invention.

When used in non-disruptive sewage pipe renovation, the film according to the invention is preferably used as an outer film, preliner film and/or inner tube film with a layer to be adhered to the resin. Here, a layer with POP or POE is pointed towards the resin, in which case the resin is preferably inserted into the sewage pipe with a carrier material such as glass fibers, for example, by impregnating. The resin impregnation step and the making contact with the film according to the invention take place either at the tube liner factory (which is often the [preferred variant) or directly at the work site. Afterwards, the tube liner is pulled into the pipe or turned inside out. During the course of the exothermic resin reaction (i.e. when the resin hardens), heat is generated in the range of approx. 70 to 140° C., preferably from 100 to 130° C. This heat then activates the layer with the POP or POE, and the result is a tight bond with the resin after cooling. This process can be helped by surface treatment of the layer that contains the POP or POE.

In principle, the preparation for inserting the tube liner resembles the state of the art, with the difference that at the work site (i.e. where the liner is used) the film layers correspondingly activated with the resin bond with the respective carrier once it is cured because a higher temperature is set during resin curing.

According to a preferred application, the film is used as inner tube film whereby the film side intended for applying the resin is arranged closer to the sewage pipe axis and the resin layer to be applied is arranged closer to the sewage pipe wall. In this case, the inner tube film remains inside the sewage pipe after the resin has been cured. To facilitate the curing of the resin from the inner side of the sewage pipe by pulling a UV emitter through it, for example, the inner tube film is advantageously permeable, at least partially, to UV radiation, preferably at least 20%, especially preferably at least 50% and ideally at least 70%. The term “UV radiation” as used here is understood to be, within the framework of this invention, electromagnetic radiation having a wavelength within the range of 200 to 400 nm.

According to a preferred alternative embodiment, the film according to the invention is executed as external or external tube film, whereby the film side intended for applying the resin or bonding with the resin is arranged closer to the sewage pipe wall and the resin to be applied is arranged closer to the swage pipe axis and whereby the external tube film advantageously absorbs and/or reflects UV radiation. As a result of this, the premature curing of the resin caused by natural or artificial light is prevented when the tube liner is stored. The tube liner can be folded or wound up in a box for storage and transportation.

According to an advantageous embodiment, both the inner tube film and the outer tube film are executed as film according to the invention. These, in turn, also have one layer with at least one layer with at least one POP or POE, in which case the corresponding layer is firmly and directly bound to the resin when it has been cured.

In a preferred embodiment, the film according to the invention is executed as inner external film, preferably available as flat film. Accordingly, the tube liner is structured as follows: a) Inner tube film (can be executed according to the invention), b) carrier/resin, c) resin-adhering inner external film (executed according to the invention), d) UV- and light-proof external outer film. Here, the inner external film executed according to the invention is spirally wound up (e.g. in striped shape having an approximate width of 50 to 400 mm) around the impregnated half liner, i.e. inner tube film and carrier/resin. Of special importance here is that the wrapping around should be absolutely impervious so no monomers or chemicals can come out. To achieve this, a very good adherence of the inner external film according to the invention is necessary on the one hand and, on the other hand, this film must adhere to its overlapping sections and be capable of bonding.

The bonding of the resin to the film, on the one hand, and also of the one film side to the other one, on the other hand, (in the “displaced” or stretched or spiral winding with edge overlapping), especially preferred by thermal activation, is reached during the course of the resin's exothermic curing. Temperatures of about 65° C. to 130° C. are usually the norm when this occurs. Since in this embodiment, the film according to the invention is located on the external side of the resin, and the resin is cured by a UV source from the inside (usually by a UV source pulled through the pipe and tube liner interior), the temperature is lower in this external area and fluctuates between 65° C. to 90° C. Even with these lower temperatures, the bonding of the film with the resin must take place, on the one hand, and the film must be bonded with itself in the overlapping areas, on the other hand. Therefore, the two sides of the film according to the invention bond with one another preferably at temperatures between 50° C. and 130° C., and very preferably between 65° C. and 90° C. This can be advantageously accomplished in such a way that the external layer of the external film according to the invention that makes no contact with the resin has a melting point within the range of 50° C. to 130° C., preferably between 65° C. and 90° C.

This is accomplished by also lowering the melting point of the other film side that does not point to the resin. According to a preferred embodiment, EVAc (ethylene vinyl acetate copolymer) is added to that external layer of the inner external film according to the invention that faces away from the layer containing POP or POE. In the lengthwise displaced, spiral winding of this inner external film around the resin layer, this external layer containing EVAc bonds with the layer containing POP or POE in the overlapping areas when heat is applied. The result is a fully impervious tube liner that also makes it more stable.

Generally, to lower the melting point of the above-mentioned external layer of the film according to the invention that faces away from the resin-adhering layer, preferably to a melting point between 50° C. and 130° C. and very preferably between 65° C. and 100° C., one or several of the following compounds can be added to this layer, particularly in addition to a relatively high proportion of polyolefin homo- or copolymer (especially more than 50% by weight) in this layer, as in an LDPE:
(if need be, additional) polyolefin homo- or copolymers;
Polyvinyl acetate homo- or copolymers;
(Meth)acrylic acid ester homo- or copolymers;
Polyethers;
Ionomers;
Polyvinyl acetals;
Polyurethanes;
Copolymers of the compounds listed above such as ethylene vinyl acetate copolymers (EVA or EVAc).

Generally, the lowering of the melting point achieves that if the film according to the invention is used as external film, a bonding of the two external sides of the film according to the invention also initiated by temperature can be maintained. In other words, when the film according to the invention is used as external film, it behaves like an adhesive tape that is spirally wound around the resin for sealing and strengthening purposes, in which case the adhesive property and subsequent bonding are induced by the temperature increase during the course of the exothermic resin curing.

If a multilayered film is available, then this behavior of the film according to the invention (i.e. the adhesive effect of the two external layers against one another when the resin layer is wrapped around within the range of 50° C. to 130° C.) can also be attained by introducing POP and/or POE in both external layers of the film.

Also advantageous and part of the invention is an arrangement in which both the inner tube film and the inner external film are executed according to the invention—i.e. that in each case, a film according to the invention is arranged on both sides of the resin and these two films have at least one POP or POE for direct, permanent resin adhesion.

It should be pointed out that the usual anti-blocking agents can be added to prevent a possible blocking of the film.

Alternative applications of the film according to the invention in non-disruptive sewage pipe renovation that employs the tube liner technique are the use as preliner (sliding and protective tube, see below), placed tightly against the sewage pipe wall, the use as sliding film with a largely semicircular cross section, placed tightly against the lower area of the sewage pipe wall, the use as calibration hose and/or the use as protective film that in certain embodiments is arranged between an inner tube film and the resin layer, and in this case is placed directly against the resin layer of the tube liner.

With regard to what was mentioned above, a preliner (also known as preliner film) is a thick-walled film that lines the pipe fully (according to the state of the art, usually made of high density polyethylene (HDPE) placed tightly against the pipe's inner wall for protecting and lowering the friction of the tube liner. After the preliner is inserted, the tube liner is drawn into the tube (drawing-in process) or inverted (inversion process) into the tube. For example, the preliner prevents an adhesion of the tube liner's synthetic resin to the pipe wall so the still uncured resin can make no contact with dirt and water. Furthermore, the preliner film also prevents resin from escaping out of the sewage pipe renovation system and contaminating the soil and groundwater. The preliner film also protects the intakes from the penetration of excessive resin, so that no resin plugs and obstructions can form. In the drawing-in process, a preliner's function is also similar to the one of known sliding films that have mostly the cross-sectional shape of a semicircle and are placed tightly against the pipe's inner wall. In this case, the low friction coefficients between the sliding film and the tube liner's external film are especially important. As a result of this, the tube liner is not damaged by the pipe's inner wall or objects inside the pipe when it is drawn into in it and, on the other hand, this reduces the friction between tube liner and sliding film considerably, thus facilitating the drawing-in of the tube liner.

The function of a calibration tube within the meaning of this invention corresponds largely to the inner tube film in the system of UV-/light-curing glass fiber liners and in a tube liner is also arranged like the inner tube film. Frequently, according to state of the art, a calibration film is bonded on its outer tube side (i.e. when used towards the pipe wall) with a fleece or felt. When a calibration tube is used, an inner tube film can be dispensed with. In this case, when using the film according to the invention as calibration hose, resin can be applied on both sides as well. Preferably, the resin is brought into contact with the film in the form of a carrier impregnated with resin, for example glass fibers or synthetic fiber felts. The layer(s) that can be activated of the film according to the invention then bind (s) with the resin or a resin-impregnated carrier material (such as fleece, felt or fabric, etc.) and a “pipe-in-pipe” system is obtained as a result of this. When using a calibration hose, the succession is therefore the following, for example: Outside, pipe wall (if needed, preliner film), then external resin-adhering film of the tube liner according to the invention or coating, then resin layer or carrier layer impregnated with resin (constitutes the external pipe), then once again a film according to the invention. By filling the calibration hose from the inside with water, compressed air, etc., the tube liner is mounted on the pipe to be renovated.

A system for non-disruptive sewage pipe renovation can have one or several films according to the invention. Currently, the use of only one film according to the invention is preferred in such a system (as inner tube film, outer tube film, wound-up inner external film, preliner or sliding film). According to the preceding description, these films can also be combined with one another in the most varied ways, however.

The film according to the invention can also be used advantageously in other fields, but in principle all them are technical fields in which the aim is to bond a film permenently with resin. The corresponding fields of application are in shipyards, the use of plastic strengthened with glass fiber, aircraft construction, in the prepreg industry, laminate manufacturing with resins, surface finish of resins, lining of tanks and containers made of resin and carrier from the inside and outside, etc.

The at least one layer mentioned above can contain at least one polyolefin plastomer or polyolefin elastomer in a percent by weight proportion between 0.1 and 100. There is a significant leeway here depending on the field of application and the desired properties.

According to a preferred embodiment, the at least one layer mentioned above contains at least one polyolefin plastomer or polyolefin elastomer with more than 30% by weight. Preferably, the % by weight proportion is present in more than 40% by weight and especially preferred in more than 50% by weight.

According to advantageous embodiments, the at least one layer mentioned above or the at least additional film layer contains at least one additional polymer that is preferably from the following group:
Olefin homo- or copolymers, especially polyethylene (PE) or polypropylene (PP);
Polyamides (PA);
Amorphous thermoplasts, such as polystyrene (PS) and polyvinyl chloride (PVC);
Polyesters, preferably polyethylene terephthalate (PET);
Polyurethanes;
Acryl ester polymers and copolymers;
Styrene acryl nitrile;
Polyvinyl esters such as polyvinyl acetate;
Polyvinyl acetals;
Polyvinyl alcohols;
Polyethers;
Polycarbonates
Polyhydroxy alkanoates;
Polysaccharides, cellulose, starch;
Copolymers of the compounds listed above.

Here, the specific application and the desired properties determine the choice of compounds. The proportion of the one polymer or additional ones can be up to an overall 99.9% by weight.

To improve the adhesive properties of the resin even more during the course of the curing process, the film side intended for the resin application can undergo preliminary treatment to increase surface tension. A corona, plasma and/or flame treatment are preferably considered for such pre-treatment.

Preferably—especially if the film according to the invention is to be used as inner tube film in non-disruptive sewage pipe renovation (see above)—the film should be essentially or largely permeable to UV light so the latter can cure the resin applied on the film. If the film according to the invention finds a use as outer tube film in non-disruptive sewage pipe renovation (see above), it is better for the film to be, on the other hand, essentially or largely impermeable to UV light so the resin to be applied on the film is precisely not cured during storage of the film (including the applied resin layer).

It is an advantage if the film according to the invention has, particularly when used as inner tube film, a radial ductility of at least 15%, preferably of at least 20% and ideally of at least 25%. This ductility is especially advantageous when the film according to the invention finds its use as inner tube film in non-disruptive sewage pipe renovation because in this way a large diameter area can be covered in the pipes that will undergo renovation. Advantageously, a break of the film in the blowing test takes place only after it has stretched more than 100%.

Preferably, particularly if the film according to the invention is used as the inner tube film mentioned above, the film according to the invention remains stable when exposed to resins and is not affected or damaged by the resin. It is possible, however that interactions can take place between the side of the film according to the invention intended to be applied with resin and the resin (such as swelling and/or blocking). The film according to the invention is thus not affected by the resin application. A swelling of the film according to the invention with resin must not have negative consequences Harz because in this case, the resin can even penetrate to a certain extent the layer of the film according to the invention to be adhered to the resin, something that can promote the bonding of film and resin after the latter has been cured.

Advantageously, the film according to the invention has at least one autonomous barrier layer impervious to monomers such as styrene, for example, with up to 100% by weight of polyamide (PA), for example. This prevents resin components from entering or penetrating into the film. Alternatively or additionally, the at least one barrier layer boasts a gas barrier that contains, for example, up to 100% by weight of EVOH. In this case, at least two different barrier layers can be present, for example, a first one impervious to monomers, and a second barrier layer impervious to gases. Alternatively, both barriers can be incorporated in one single layer. A layer consisting of a cyclic olefin copolymer (COC) barrier layer impervious to water is recommended.

The number of layers can be chosen depending on application field. Here, monofilms with only one layer (according to the invention) and multilayered films with many layers are possible. Merely as an example, three, four, five, seven, and even up to 25 and more layers are possible. In all of these multilayered films, according to the invention, at least one of the two external layers contains at least one of above-mentioned polyolefin plastomer or polyolefin elastomer. Exemplary layer successions are:

In a 3-layered structure:

(PE+POP or POE)/adhesive promoter (AP)/polyamide (PA); or

(PA+POP or POE)/adhesive promoter (AP)/PE.

In a 5-layered structure:

(PE+POP or POE)/AP/PA/AP/PE; or

(PA+POP or POE)/AP/PA/AP/PE.

According to an advantageous embodiment, the film according to the invention has at least one autonomous layer that contains a thermoplastic olefin homo- or copolymer, advantageously more than 50% by weight of it, preferably more than 75% by weight of it, and ideally more than 95% by weight of it. Within the meaning of this invention, olefin homo- or copolymers are thermoplastic polymers of α,β unsaturated olefins having two to six carbon atoms such as polyethylene (PE, especially LDPE or HDPE), polypropylene (PP), polybutylene (PB), polyisobutylene (PI), for example, or mixtures from at least two of the above-mentioned polymers. “LDPE” is a low density polyethylene having a density within the range of 0.86 to 0.93 g/cm³ and characterized by a high molecular branching. “HDPE” is a high density polyethylene with slight branching of the molecular chains whose density can lie within the range of 0.94 to 0.97 g/cm³. The preferred olefin homo- or copolymer is polyethylene (PE), preferably used in the form of high density polyethylene (HDPE). However, LDPE and/or LLDPE (linear low density polyethylenes) can also be advantageously employed. Furthermore, polyolefins, especially polyethylenes that were polymerized by means of metallocen catalysts (mPE), such as mLDPE (metallocen LDPE) and mLLDPE (metallocen LLDPE), are also suitable. Polyethylene is classified in different categories, mainly according to its density and branching. Its mechanical properties depend greatly on variables like length and type of branching, crystal structure and molecular weight. The top-selling polyethylenes are HDPE, LLDPE and LDPE. According to another advantageous alternative, polypropylene (PP) finds its use as olefin homo- or copolymer. Mixtures of various olefin homo- or copolymers, including those listed above, are by all means possible.

The autonomous layer mentioned above with at least one thermoplastic olefin homo- or copolymer is preferably intended as that external layer of the film according to the invention that is opposite to the external layer containing at least one POP or POE.

To manufacture the above-mentioned adhesive promoter layer(s), conventional adhesive promoters can be employed. Preferably, the adhesive promoter layer(s) should contain—in each case independently from one another—at least one modified thermoplastic polymer, preferably at least one modified olefin homo- or copolymer. The same olefin homo- or copolymers can be employed as olefin homo- or copolymers that were already mentioned above, only in a modified way. It is especially preferable if the adhesive promoter layer(s) contain(s)—in each case independently from one another—at least one modified ethylene homo- or copolymer and/or at least one modified propylene homo- or copolymer, modified with at least one organic acid or at least one, preferably cyclic, organic acid anhydride, preferably with maleic acid anhydride. Ethylene vinyl ace-tate, ethylene vinyl alcohol (EVOH), and ethylene (meth)acrylate copolymers, either in their modified or unmodified form, are ideally suited as adhesive promoters.

According to the previous description, a 7-layer film can be exemplarily structured as follows:

| Layer | | Proportion | Thickness in | |
|---|---|---|---|---|
| number | Composition | of layer in % | μm | |
| 1 | POP | 80 | 16-20 | |
| | LDPE | 20 | | |
| 2 | AP | 100 | 3-6 | |
| 3 | PA | 100 | 2 | |
| 4 | EVOH | 100 | 4 | |
| 5 | PA | 100 | 2 | |
| 6 | AP | 100 | 3-6 | |
| 7 | LDPE | 100 | 14-18 | |
| | | | Total thickness: 44-58 | μm |

An exemplary 5-layered film can have the following structure:

| Layer | | Proportion | Thickness in | |
|---|---|---|---|---|
| number | Composition | of layer in % | μm | |
| 1 | POP | 80 | 25-35 | |
| | LDPE | 20 | | |
| 2 | AP | 100 | 4-8 | |
| 3 | CoPA | 100 | 20-30 | |
| | (co-polyamides) | | | |
| 4 | AP | 100 | 4-8 | |
| 5 | LDPE | 100 | 25-35 | |
| | | | Total thickness: 78-116 | μm |

Preferably, the film side intended for the resin application can be activated with heat. Such a layer that can be thermally activated can be easily provided during the course of the film extrusion (cast extrusion, blow extrusion) or also through extrusion coating with the polyolefin plastomers or the polyolefin elastomers that can be activated. In this case, it is advantageous if the activation temperature remains below 130° C., preferably below 100° C.

The layer intended for the resin application or resin bonding has preferably a thickness of 1 to 500 μm, preferably of 5 to 200 μm, very preferably of 10 to 100 μm and ideally of 15 μm to 80 μm.

The film according to the invention has preferably an overall thickness of 20 to 1000 μm, preferably of 40 to 400 μm, especially of 50 to 250 μm.

Apart from the film according to the invention and the various uses, the invention also refers to an arrangement with at least one film according to the invention and at least one resin layer on one of the two film sides. According to what has been mentioned above, the resin is mixed with a carrier material such as glass fibers, for example, or applied on a carrier material such as fleece, for example, in which case there is a direct bonding between film and resin (instead of the fleece, as is the case in the state of the art). Here, the invention refers both to an arrangement of a film with still uncured resin (in which the resin has not bonded tightly with the film) and to an arrangement of a film with resin that has bonded permanently and tightly with the film after the resin has cured.

The invention likewise refers to a resin-hardened or not completely resin-hardened arrangement, in which a film according to the invention is intended for both sides of the resin, whereby in the layer facing the resin there is at least one POP or POE for direct permanent resin adhesion after resin hardening.

Reactive plastic resins that can be used are, for example, commercially available UP resins (polyester or unsaturated polyester resins), VE resins (vinyl ester resins) or EP resins (epoxy resins). With UP or VE resins, their hardening takes place with the help of photoinitiators, for example, but hardening can also be accomplished with heat. Examples of usable, commercially available resins are unsaturated polyester resins of type 1140 of DIN 16 946-2 according to Table 3, corresponds to group 3 of DIN 18 820 in Table 1. Examples of more resin formulations are found in DE10 2011 002 032 A1.

For example, a typical resin consists of: 42.5% by weight of styrene, 21% by weight of neopentyl glycol, 18% by weight of phthalate acid, 14% by weight of maleic acid, 4% by weight of monopropylene glycol. As initiator, it contains a photoinitiator (e.g. 0.5% by weight of Irgacure 819 made by Ciba AG) that can be activated by UV.

In such an arrangement according to the invention, the film according to the invention is preferably arranged between the sealed resin layer and at least one additional layer consisting preferably of a non-woven or woven material made of paper or cardboard.

The invention likewise refers to a tube liner having one or more films according to the invention mentioned above and/or an arrangement of film(s) and resin according to the invention. Then, such a tube liner has the remaining known components, i.e. those that are not part of the at least one film according to the invention or the arrangement according to the invention. If, for example, the arrangement of inner external film and resin layer is structured according to the invention, a tube liner according to the invention has additionally, in particular, the outer external film and the inner tube film.

Preferably, the film according to the invention contains—depending on the specific application—one or several of the following compounds in at least one of the film layers: polystyrene (PS); polyhalogenides such as PVC and/or polyvinylidene chloride (PVdC), for example; ethylene vinyl alcohol copolymer (EVOH), polyvinyl alcohol (PVOH or PVAL), adhesive promoters, ethylene vinyl acetate (EVAc); one or several ionomers; one or several poly(meth)acrylates; ethylene-containing poly(meth)acrylate, polyvinyl acetate (PVAc); polycarbonate (PC); polyacryl nitrile (PAN); additional polyesters such as polybutylene terephthalate (PBT), polyethylene naphthalate (PEN), polylactic acid (PLA) and/or polyhydroxy alkanoate (PHA); one or several ethylene acrylic acid copolymers (EAA); polyvinyl butyral (PVB); polyvinyl acetal; cellulose acetate (CA); cellulose acetobutyrate (CAB); polysaccharides; starch; cyclic olefin copolymer (COC).

To improve the film's properties, one or several of the following compounds or additives can be added during the course of the extrusion in one or several steps. Some of these additives can be adhesive promoters, functionalized polymers such as EVOH, optical brighteners, thermal stabilizers, lubricants, antioxidants, oxygen scavengers, spacers (e.g. silica particles, SAS), slip-/anti-blocking agents, dyes, pigments, foaming agents, antistatic agents, process aids, lubricating agents, fire retardants, flame inhibitors, impact modifiers, impact resistance improvers, anti-hydrolysis agents, UV absorbers, UV repellents, stabilizers, anti-fog additives, waxes, wax additives, separators, sealing or peeling additives, nucleation agents, compatibilizers, fluxing agents, flow improvers, melt strength enhancers, molecular weight raisers, cross-linking agents or softeners.

The films according to the invention can also be manufactured in various ways. A preferred manufacturing method utilizes extrusion or co-extrusion, for example blown film extrusion or cast extrusion. The most popular is the manufacturing method that produces a tubular blown film.

Another preferred manufacturing method is coating, especially extrusion coating, used in particular for applying the layer containing POP or POE and/or an external film layer that lowers the melting point, especially through additives like. EVAc, for example.

Preferably, the film according to the invention is not oriented. Furthermore, it is preferably capable of being sealed even if it has no sealing seam when executed as inner tube film.

The film according to the invention can also be foamed or contain at least one foamed layer.

Furthermore, powder or talc can still be added to the film's surface (the use of talc is preferred).

Further processing options consists in bringing the film according to the invention together with a scrim or knitted fabric, e.g. a plastic net or screen. Alternatively, this screen, scrim or knitted fabric can be introduced into the film for purposes of additional strengthening.

### BRIEF DESCRIPTION OF THE DRAWINGS

The invention is explained in more detail with the help of figures, which show:

FIG. 1 cross section through a sewage pipe to be renovated with a preliner and a tube liner, and

FIG. 2 side view of an inner external film, spirally wound.

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

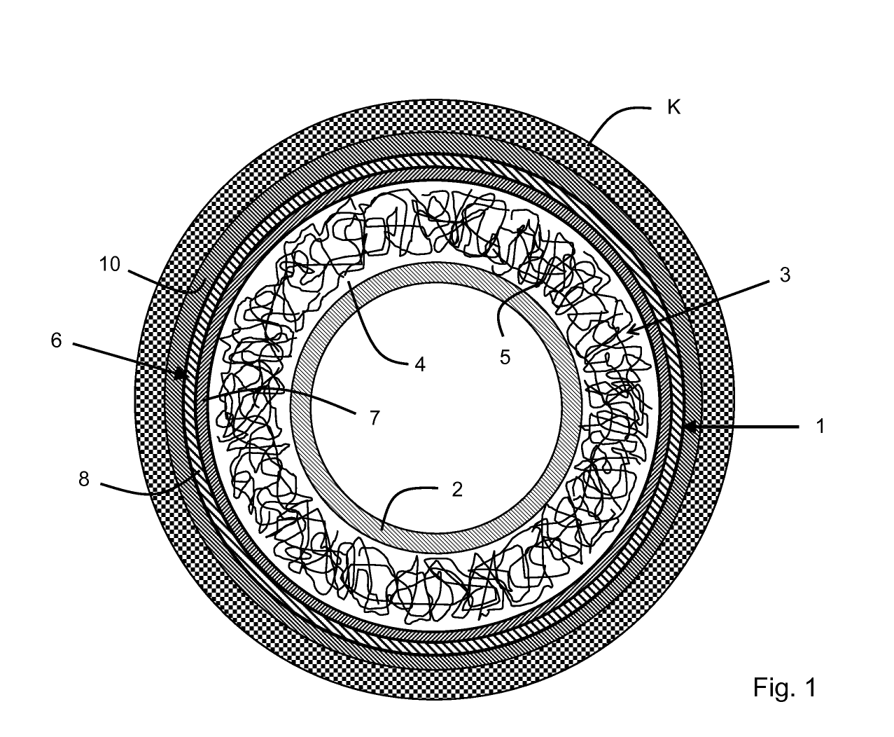

FIG. 1 shows a full system of a sewage pipe K to be renovated into which a known preliner 10 known from the state of the art has been drawn that makes contact with the wall of the sewage pipe K. The preliner 10 encompasses a tube liner 1, which contains here a (preferably for the most part UV- and light-permeable) inner tube film 2, a resin carrier system 3, which contains resin 4 and, for example, glass fibers 5 as carriers, as well as a system 6 made up of—in the embodiment shown—an inner external film 7 and an outer (preferably for the most part impervious to UV and light) external film 8. There can also be an inner and outer external film 7, 8. Instead, only one single external film can be especially provided.

In an advantageous embodiment of the invention, the layer of the inner tube film 2 facing the resin 4 contains at least one POP or POE corresponding to what was mentioned above. Here, the inner tube film 2 can have a structure that corresponds, for example, to the embodiments described below, in which case all these films are multilayered ones. During the course of resin hardening—done mostly by guiding a UV light source through the subsequently inflated tube liner 1—the resin 4 bonds directly with the layer of the inner tube film 2 that contains the POP or POE according to the invention.

In the preceding embodiment, an arrangement according to the invention is created from the inner tube film 2 and the resin 4, which has been furnished especially with a carrier material or is embedded in a carrier material 5.

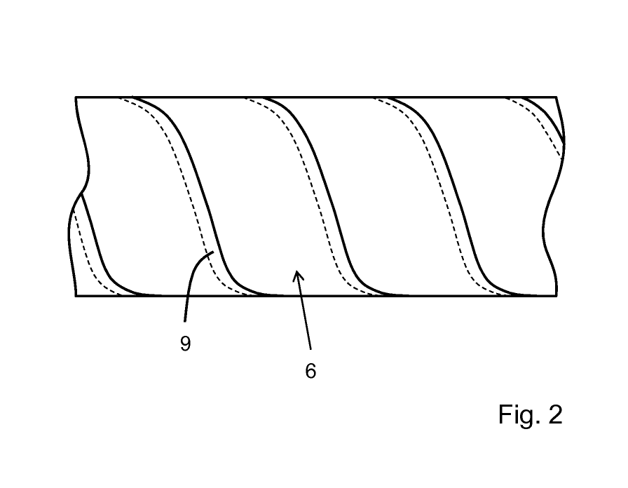

In another advantageous embodiment of the invention, the inner external film 7 is executed as film according to the invention, whereby the layer of the external film 7 containing at least one POP or POE is the layer facing the resin 4. This inner external film 7 is preferably a flat film wound spirally around the resin-carrier system 3 with overlapping areas 9, as shown in the lateral view of the inner external film 7 according to FIG. 2. Since this winding around must be absolutely impervious, particularly to prevent monomers or chemicals from escaping, the inner external film 7 must adhere and bond to itself in the overlapping areas 9. The bonding with the resin 4 (on the layer of the inner external film 7 pointing to the pipe's interior) and the bonding of the two external film layers in the overlapping areas 9 is achieved by thermal activation during the course of the resin's exothermic hardening, in which temperatures within the range of about 65° C. to 130° C. take place. Since the overlapping areas 9 are arranged on the side of the inner external film 7 that faces away from the resin 4, when hardening occurs owing to a UV source being pulled through the pipe formed by the tube liner 1, a temperature of only about 65° C. to 90° C. is reached in the overlapping areas 9. Therefore, the bonding of the inner external film 7 must already take place in the overlapping areas 9 with these temperatures. So this can be achieved, the melting point of the film layer of the inner external film 7 that faces away from the resin 4 is lowered, according to an especially preferred embodiment by adding EVAc (ethylene vinyl acetate copolymer). The layer of the inner external film 7 that contains POP or POE therefore bonds, on the one hand, directly with the resin 4 and, on the other hand, tightly in the overlapping areas 9 with the other external layer of the inner external film 7 developed according to the invention.

In the above-mentioned embodiment, an arrangement according to the invention is formed by the inner external film 7 and the resin 4, which is especially furnished with a carrier material or is embedded in a carrier material 5.

An embodiment likewise shown in FIGS. 1 and 2 provides that both the inner tube film 2 and the inner external film 7 are executed as film according to the invention. In both films, the external layers that make contact with the resin contain in each case one POP or POE for permanent bonding with the resin once it has hardened. The result is an arrangement according to the invention structured like this (from the inside to the outside): inner tube film 2/resin 4 (plus carrier material 5)/inner external film 7.

According to an embodiment not shown, the external film is not divided into an inner and outer external film. Rather, there is only one external film executed preferably as flat film, but not wound spirally around the resin, as it is placed on the side of the perimeter around the resin instead and then sealed on a longitudinal seam running in lengthwise direction. Such an external film can, as film according to the invention, be executed with a film having at least one POP or POE for resin adhesion. In addition, the inner tube film can also be executed as film according to the invention (see above).

### EMBODIMENTS

The following examples and comparative examples serve for explaining the invention and should not be interpreted in a restrictive way. Various comparative examples (films V1-V10) and exemplary films according to the invention (films B1-B18) are presented below. They were tested with regard to their adhesiveness.

### I. Materials Used

The LDPE used in many examples is Lupolen 2420 F made by the LyondellBasell Polymers Co. Lupolen 3010D is also an LDPE made by LyondellBasell Polymers.

The mLLDPE used in comparative example V5 is Exceed 1018 EB made by the ExxonMobil Chemical Company. It is an ethylene copolymer manufactured by means of metallocen catalysis, in whose polymerization hexene is used as additional comonomer apart from ethylene.

Inspire 137, a polypropylene formerly from the Dow Chemical Company, is now made by Braskem.

Durethan C38 F made by Lanxess is a medium viscosity copolyamide.

Moplen EP240H is a nucleated heterophasic polypropylene copolymer made by LyondellBasell.

Admer QB510E, made by Mitsui Chemicals, is a polypropylene-based adhesive promoter modified with maleic acid anhydride groups.

Admer NF498E, made by Mitsui Chemicals, is an LDPE modified with maleic acid anhydride groups that has strong adhesion to PET, EVOH and PA, can be processed very well and has a thermal stability equivalent to conventional PE.

EVAL T101B of the EVAL Europe Co. is an ethylene vinyl alcohol copolymer (EVOH)-based polymer.

Exact 0201 made by the Borealis Plastomers v.o.f. Co. is a polyolefin plastomer (POP), more specifically an ethylene-based octene plastomer manufactured in a polymerization process in solution that employs a metallocen catalyst. Its density is 0.902 g/cm³ in accordance with ISO 1183 (at 23° C.).

Affinity PL 1850D is a polyolefin plastomer (POP) made by the Dow Chemical Company, manufactured with the help of a metallocen catalyst.

Engage 8450, from the Dow Chemical Company, is a polyolefin elastomer (POE), more specifically an ethylene octane copolymer that can be used efficiently in co-extrusion. Moreover, it is highly compatible with other polyolefins. It is likewise manufactured by means of metallocen catalysis.

Elvax 3165, made by DuPont, is an extrudable ethylene vinyl acetate copolymer resin in pellet form that can be used in conventional extruder equipment.

The resin used for resin adherence contained 42.5% by weight of styrene, 21% by weight of neopentyl glycol, 18% by weight of phthalic acids, 14% by weight of maleic acid and 4% by weight of monopropylene glycol. It contained as initiator a photoinitiator (e.g. 0.5% by weight of Irgacure 819 by CIBA) activated by UV.

### II. Manufacturing of the Multilayered Films

The multilayered films according to the invention of examples B1-B7, B9-14 and B16-18 are 5-layer films. The multilayered film according to the invention of example B15 consists of 3 layers. The multilayered film according to the invention of example B8 has seven layers. The individual layers of the multilayered films adjoin in each case directly in the order in which they are listed below (“layer number”). The external layer of each film intended for the application of the resin is always layer 1 (“to the resin”).

The films according to the invention were manufactured with blown film co-extrusion and subsequent two-sided cutting in form of flat film.

The proportion of the individual chemicals in the layers given in the tables are expressed as percentages and indicate percentages by weight.

### III. Measured Films

### Comparative example V1

Flat film 100 μm, normal PE in layer 1:

| Layer | | Proportion | Thickness | |
|---|---|---|---|---|
| number | Composition | of layer in % | in μm | |
| 1 to the resin | Lupolen 2420 F | 100 | 30 | |
| 2 | Admer NF498E | 100 | 10 | |
| 3 | Durethan C38 F | 100 | 20 | |
| 4 | Admer NF498E | 100 | 10 | |
| 5 | Lupolen 2420 F | 100 | 30 | |
| | | | Sum: 100 | μm |

### Comparative example V2

Flat film, 100 μm, normal PP in layer 1:

| Layer | | Proportion | Thickness | |
|---|---|---|---|---|
| number | Composition | of layer in % | in μm | |
| 1 to the resin | Inspire 137 | 100 | 30 | |
| 2 | Admer QB 510E | 100 | 10 | |
| 3 | Durethan C38 F | 100 | 20 | |
| 4 | Admer QB 510 E | 100 | 10 | |
| 5 | Inspire 137 | 100 | 30 | |
| | | | Sum: 100 | μm |

### Comparative example V3

Flat film, 100 μm, heterophasic polypropylene copolymer in layer 1:

| Layer | | Proportion | Thickness | |
|---|---|---|---|---|
| number | Composition | of layer in % | in μm | |
| 1 to the resin | Moplen EP 240 H | 100 | 30 | |
| 2 | Admer QB 510E | 100 | 10 | |
| 3 | Durethan C38 F | 100 | 20 | |
| 4 | Admer QB 510 E | 100 | 10 | |
| 5 | Moplen EP 240 H | 100 | 30 | |
| | | | Sum: 100 | μm |

### Comparative example V4

Flat film, 100 μm, normal PE in layer 1:

| Layer | | Proportion | Thickness | |
|---|---|---|---|---|
| number | Composition | of layer in % | in μm | |
| 1 to the resin | Lupolen 3010 D | 100 | 30 | |
| 2 | Admer NF498E | 100 | 10 | |
| 3 | Durethan C38 F | 100 | 20 | |
| 4 | Admer NF498E | 100 | 10 | |
| 5 | Lupolen 3010 D | 100 | 30 | |
| | | | Sum: 100 | μm |

### Comparative example V5

Flat film, 100 μm, normal PE in layer 1:

| Layer | | Proportion | Thickness | |
|---|---|---|---|---|
| number | Composition | of layer in % | in μm | |
| 1 to the resin | Lupolen 3010 D | 70 | 30 | |
| | Exceed 1018 EB | 30 | | |
| 2 | Admer NF498E | 100 | 10 | |
| 3 | Durethan C38 F | 100 | 20 | |
| 4 | Admer NF498E | 100 | 10 | |
| 5 | Lupolen 3010D | 100 | 30 | |
| | | | Sum: 100 | μm |

### Comparative examples V6 to V10

Comparative examples V1 to V5 underwent corona treatment on the side to which the resin should adhere. This led to a surface tension of 48 mN/m.

### Example B1

Flat film, 100 μm, normal PE with POP in layer 1:

| Layer | | Proportion | Thickness | |
|---|---|---|---|---|
| number | Composition | of layer in % | in μm | |
| 1 to the resin | Lupolen 2420 F | 20 | 30 | |
| | Exact 0201 | 80 | | |
| 2 | Admer NF498E | 100 | 10 | |
| 3 | Durethan C38 F | 100 | 20 | |
| 4 | Admer NF498E | 100 | 10 | |
| 5 | Lupolen 2420 F | 100 | 30 | |
| | | | Sum: 100 | μm |

### Example B2

Flat film, 100 μm, with 100% POP in layer 1:

| Layer | | Proportion | Thickness | |
|---|---|---|---|---|
| number | Composition | of layer in % | in μm | |
| 1 to the resin | Exact 0201 | 100 | 30 | |
| 2 | Admer NF498E | 100 | 10 | |
| 3 | Durethan C38 F | 100 | 20 | |
| 4 | Admer NF498E | 100 | 10 | |
| 5 | Lupolen 2420 F | 100 | 30 | |
| | | | Sum: 100 | μm |

### Example B3

Flat film, 100μ, normal PE with POP in layer 1:

| Layer | | Proportion | Thickness | |
|---|---|---|---|---|
| number | Composition | of layer in % | in μm | |
| 1 to the resin | Lupolen 2420 F | 50 | 30 | |
| | Exact 0201 | 50 | | |
| 2 | Admer NF498E | 100 | 10 | |
| 3 | Durethan C38 F | 100 | 20 | |
| 4 | Admer NF498E | 100 | 10 | |
| 5 | Lupolen 2420 F | 100 | 30 | |
| | | | Sum: 100 | μm |

### Example B4

Flat film, 100 μm, normal PE with POP in layer 1:

| Layer | | Proportion | Thickness | |
|---|---|---|---|---|
| number | Composition | of layer in % | in μm | |
| 1 to the resin | Lupolen 2420 F | 20 | 30 | |
| | Affinity PL 1850 G | 80 | | |
| 2 | Admer NF498E | 100 | 10 | |
| 3 | Durethan C38 F | 100 | 20 | |
| 4 | Admer NF498E | 100 | 10 | |
| 5 | Lupolen 2420 F | 100 | 30 | |
| | | | Sum: 100 | μm |

### Example B5

Flat film, 100 μm, normal PE with POP in layer 1:

| Layer | | Proportion | Thickness | |
|---|---|---|---|---|
| number | Composition | of layer in % | in μm | |
| 1 to the resin | Lupolen 3010 D | 30 | 30 | |
| | Exact 0201 | 70 | | |
| 2 | Admer NF498E | 100 | 10 | |
| 3 | Durethan C38 F | 100 | 20 | |
| 4 | Admer NF498E | 100 | 10 | |
| 5 | Lupolen 3010 D | 100 | 30 | |
| | | | Sum: 100 | μm |

### Example B6

Flat film, 100 μm, normal PE with POP in layer 1:

| Layer | | Proportion | Thickness | |
|---|---|---|---|---|
| number | Composition | of layer in % | in μm | |
| 1 to the resin | Lupolen 3010 D | 30 | 30 | |
| | Affinity PL 1850 G | 70 | | |
| 2 | Admer NF498E | 100 | 10 | |
| 3 | Durethan C38 F | 100 | 20 | |
| 4 | Admer NF498E | 100 | 10 | |
| 5 | Lupolen 3010 D | 100 | 30 | |
| | | | Sum: 100 | μm |

### Example B7

Flat film, 100 μm, normal PE with POP in layer 1:

| Layer | | Proportion | Thickness | |
|---|---|---|---|---|
| number | Composition | of layer in % | in μm | |
| 1 to the resin | Lupolen 3010 D | 30 | 42.5 | |
| | Affinity PL 1850 G | 70 | | |
| 2 | Admer NF498E | 100 | 5 | |
| 3 | EVAL T101B | 100 | 5 | |
| 4 | Admer NF498E | 100 | 5 | |
| 5 | Lupolen 3010 D | 100 | 42.5 | |
| | | | Sum: 100 | μm |

### Example B8

Flat film, 100μ, normal PE with POP in layer 1:

| Layer | | Proportion | Thickness | |
|---|---|---|---|---|
| number | Composition | of layer in % | in μm | |
| 1 to the resin | Lupolen 3010 D | 30 | 37.5 | |
| | Affinity PL 1850 G | 70 | | |
| 2 | Admer NF498E | 100 | 5 | |
| 3 | Durethan C38 F | 100 | 5 | |
| 4 | EVAL T101B | 100 | 5 | |
| 5 | Durethan C38 F | 100 | 5 | |
| 6 | Admer NF498E | 100 | 5 | |
| 7 | Lupolen 3010 D | 100 | 37.5 | |
| | | | Sum: 100 | μm |

### Example B9

Flat film, 100 μm, normal PE with POP in layer 1:

| Layer | | Proportion | Thickness | |
|---|---|---|---|---|
| number | Composition | of layer in % | in μm | |
| 1 to the resin | Lupolen 3010 D | 70 | 30 | |
| | Exact 0201 | 30 | | |
| 2 | Admer NF498E | 100 | 10 | |
| 3 | Durethan C38 F | 100 | 20 | |
| 4 | Admer NF498E | 100 | 10 | |
| 5 | Lupolen 3010 D | 100 | 30 | |
| | | | Sum: 100 | μm |

### Example B10

Flat film, 100 μm, normal PE with POP in layer 1:

| Layer | | Proportion | Thickness | |
|---|---|---|---|---|
| number | Composition | of layer in % | in μm | |
| 1 to the resin | Lupolen 3010 D | 60 | 30 | |
| | Exact 0201 | 40 | | |
| 2 | Admer NF498E | 100 | 10 | |
| 3 | Durethan C38 F | 100 | 20 | |
| 4 | Admer NF498E | 100 | 10 | |
| 5 | Lupolen 3010 D | 100 | 30 | |
| | | | Sum: 100 | μm |

### Example B11

Flat film, 100 μm, normal PE with POP in layer 1:

| Layer | | Proportion | Thickness | |
|---|---|---|---|---|
| number | Composition | of layer in % | in μm | |
| 1 to the resin | Lupolen 3010 D | 90 | 30 | |
| | Exact 0201 | 10 | | |
| 2 | Admer NF498E | 100 | 10 | |
| 3 | Durethan C38 F | 100 | 20 | |
| 4 | Admer NF498E | 100 | 10 | |
| 5 | Lupolen 3010 D | 100 | 30 | |
| | | | Sum: 100 | μm |

### Example B12

As example 11, but with the difference that the side intended for resin adhesion underwent Corona treatment, which led to a surface tension of 48 mN/m.

### Example B13

Flat film, 100 μm, normal PE with POP in layer 1:

| Layer | | Proportion | Thickness | |
|---|---|---|---|---|
| number | Composition | of layer in % | in μm | |
| 1 to the resin | Lupolen 3010 D | 99 | 30 | |
| | Exact 0201 | 1 | | |
| 2 | Admer NF498E | 100 | 10 | |
| 3 | Durethan C38 F | 100 | 20 | |
| 4 | Admer NF498E | 100 | 10 | |
| 5 | Lupolen 3010 D | 100 | 30 | |
| | | | Sum: 100 | μm |

### Example B14

As example 13, but with the difference that the side intended for resin adhesion underwent corona treatment, which led to a surface tension of 48 mN/m.

### Example B15

Flat film, 100 μm, normal PE with POP in layer 1:

| Layer | | Proportion | Thickness | |
|---|---|---|---|---|
| number | Composition | of layer in % | in μm | |
| 1 to the resin | Lupolen 3010 D | 30 | 35 | |
| | Affinity PL 1850 G | 70 | | |
| 2 | Lupolen 3010D | 30 | 30 | |
| 3 | Lupolen 3010 D | 30 | 35 | |
| | | | Sum: 100 | μm |

### Example B16

Flat film, 100 μm, heterophasic polypropylene co-polymer with POP in layer 1:

| Layer | | Proportion | Thickness | |
|---|---|---|---|---|
| number | Composition | of layer in % | in μm | |
| 1 to the resin | Moplen EP 240 H | 30 | 30 | |
| | Exact 0201 | 70 | | |
| 2 | Admer NF 498 E | 100 | 10 | |
| 3 | Durethan C38 F | 100 | 20 | |
| 4 | Admer QB 510 E | 100 | 10 | |
| 5 | Moplen EP 240 H | 100 | 30 | |
| | | | Sum: 100 | μm |

### Example B17

Flat film, 100 μm, normal PE with polyolefin elastomer in layer 1:

| Layer | | Proportion | Thickness | |
|---|---|---|---|---|
| number | Composition | of layer in % | in μm | |
| 1 to the resin | Lupolen 2420 F | 20 | 30 | |
| | Engage 8450 | 80 | | |
| 2 | Admer NF498E | 100 | 10 | |
| 3 | Durethan C38 F | 100 | 20 | |
| 4 | Admer NF498E | 100 | 10 | |
| 5 | Lupolen 2420 F | 100 | 30 | |
| | | | Sum: 100 | μm |

### Example B18

Flat film, 100 μm, normal PE with POP in layer 1:

| Layer | | Proportion | Thickness | |
|---|---|---|---|---|
| number | Composition | of layer in % | in μm | |
| 1 to the resin | Lupolen 2420 F | 20 | 30 | |
| | Exact 0201 | 80 | | |
| 2 | Admer NF498E | 100 | 10 | |
| 3 | Durethan C38 F | 100 | 20 | |
| 4 | Admer NF498E | 100 | 10 | |
| 5 | Lupolen 2420 F | 80 | 30 | |
| | Elvax 3165 | 20 | | |
| | | | Sum: 100 | μm |

### IV. Determination of Resin Adhesion

A film provided in form of a DIN A4 sheet (format: 210 mm×297 mm) is placed fittingly in a rectangular metallic trough having the following dimensions: length 250 mm, width 220 mm and height 10 mm, fastened to the trough with adhesive tape on three sides (once completely widthwise, twice completely lengthwise) so that about 5 cm of film can still protrude out of a width side and project from the trough.

The resin formulation (including the 0.5% by weight of photoinitiator) Is poured into the film-covered trough, in such a way that the resin fills the trough about half way (approx. 275 mL). The film is therefore fully covered with resin—except for the part of the film that projects from the trough. In this experimental set-up, the resin cannot reach the trough under the film because it was sealed from above with adhesive tape.

Afterwards, the resin is irradiated for 10 minutes using a UV lamp until it fully hardens on the film, whose side facing the resin is activated by the heat. The exothermic polymerization reaction of the resin can generate temperatures of about 100 to 130° C. in this experimental set-up.

Then, the film is pulled from the trough with a “removal tab” that protrudes from the trough. A film almost completely covered with cured resin is obtained in this way.

To determine resin adhesion, the film is subsequently removed manually from the resin. The assessment is done with a school grading system, in which the grade of A indicates that the film is inseparably bonded with the resin and cannot be pulled off from it without damage. The grade of F means that the film is very easily detached from the resin.

The results obtained with the experimental set-up described above are measured once again by using the following test: A metal ring having a 5 cm inner diameter and an approximate height of 3 cm is placed on the film's outer side (i.e. the side intended for resin adhesion in this invention). The resin is poured into this metal ring in such a way that it reaches a height of about 5 mm on the edge of the metal ring. Afterwards, the resin is completely hardened with a UV lamp. The bonding to the resin is determined by first removing the metal ring and then pulling the resin from the film. If the resin has bonded fully with the film, this cannot be done without damage. The school grading system mentioned above also applies here to quantify the resin adhesion.

### V. Results

In all cases, the same result was obtained with the first experimental set-up than with the second one. For this reason, only one resin adhesion observation and one school grade are given below.

| Comparative | Resin adhesion, | Resin |
|---|---|---|
| example/example | school grade | adhesion |
| V1 | F | fail |
| V2 | F | fail |
| V3 | F | fail |
| V4 | F | fail |
| V5 | F | fail |
| V6 to V10 | F | fail |
| B1 | A | very good |
| B2 | A | very good |
| B3 | B | good |
| B4 | A | very good |
| B5 | A | very good |
| B6 | A | very good |
| B7 | A | very good |
| B8 | A | very good |
| B9 | C | fair |
| B10 | B | good |
| B11 | D | sufficient |
| B12 | B | good |
| B13 | F | fail |
| B14 | D | sufficient |
| B15 | A | very good |
| B16 | A | very good |
| B17 | B | good |
| B18 | A | very good |

### Interpretation of the Results

In the films from comparative examples V1 to V5, no adhesion to the hardened resin could be achieved whatsoever with the materials typically used in blown film manufacturing such as LDPE (Lupolen 2420 F in layer 1 facing the resin) or PP (Inspire 137 in layer 1 facing the resin). It was not possible either with a mixture of LDPE and metallocen LLDPE in layer 1 facing the resin (comparative example V5).

In comparative examples V1 to V5, there was no change either if the sides to be bonded with the resin were subject to corona treatment at a surface tension of 48 mN/m: Adhesion to the resin always remained insufficient (comparative examples V6 to V10).

If, on the other hand, a polyolefin plastomer (POP) is used in the side that will be bonded with the cured resin, then the film will bond very well with the resin after its curing and can no longer be removed from the resin without damage. This is very impressively shown in examples B1 (80% POP, here: Exact 0201) and B2 (100%, POP, here: Exact 0201).

In example B3, POP content was reduced by 50% in the film side to be bonded with the cured resin, but resin adhesion was still good (school grade B).

Example 4 shows that resin adhesion can apparently be accomplished with any POP. In this case, a POP made by the Dow Chemical Company was used, whereas in the analogous example 1, a POP from the Borealis Co. was used. Outstanding adhesion to the resin was also seen in example B4 (grade A).

Even the comparison of examples B5 (POP: Exact 0210) and B6 (POP: Affinity 1850 G), in which the films differed only from the material of the used POP in the side to be bonded with the cured resin, proves that the resin adhesion effect can apparently be achieved in general with all POP materials. Both films from examples B5 and B6 had outstanding adhesion to the cured resin.

That in resin adhesion only the external layer with the POP matters is demonstrated by examples B7 and B8. As expected, changing one or more internal layers (here, the use of EVOH in example 7 instead of polyamide in example B6, as well as the use of PA and EVOH in example B8) does not play a role when it comes to resin adhesion, which in these two cases is once again outstanding (grade A).

In examples B9 to B11 and B13, and for comparison also examples B1 (here, however, with LDPE Lupolen 2420 F, instead of with LDPE Lupolen 3010 D as with all other examples B9-B11 and B13 mentioned in this comparison), B2, B3 and B5, the mixing ratio in which the layer to be bonded with the resin varies between one LDPE and one POP, otherwise the films had in each case an analogous structure. The following results were obtained with regard to the adhesion of the film to the cured resin (same results as above, but only mixing ratios are given here):

| | Mixing ratio LDPE/POP in layer | Resin adhesion |
|---|---|---|
| Example | towards resin adhesion (layer 1) | (school grade) |
| B2 | 0/100 | A |
| B1 | 20/80 | A |
| B5 | 30/70 | A |
| B3 | 50/50 | B |
| B10 | 60/40 | B |
| B9 | 70/30 | C |
| B11 | 90/10 | D |
| B13 | 99/1 | F |

This table shows that as POP content is lowered in the layer that will later bond with the cured resin, resin adhesion is also successively lowered.

Thus, there is only a fair, sufficient or failing adhesion of the film with the resin to be cured in examples B9, B11 and B13.

It was also surprisingly discovered, however, that a small quantity of POP in the layer to be bound with the resin is also enough to attain a noticeably better resin adhesion in this layer after all through a Corona pre-treatment. Thus, in example B11 (not pre-treated: sufficient resin adhesion, school grade D), the corona treatment led to good adhesion to the resin (example B12, school grade: B). In example B13 (not pre-treated: failed resin adhesion, school grade F), the corona treatment led at least to a barely sufficient adhesion to the resin (example B14, school grade: D).

However, a comparison with comparative examples V1 to V5 shows that resin adhesion cannot be improved by a corona treatment (V6 to V10) when there is no POP in the layer that will bond with the resin.

The utilization of barrier materials PA and EVOH had a double significance in the examples and comparative examples: On the one hand, in the polyamide example it offers an outstanding barrier against the monomers and oils found in the still uncured resin, and this prevents an unpleasant odor from forming. On the other hand, polyamide also induces considerably better mechanical properties in the film—and they were in demand here because in order to peel off the films from the cured resin, a large amount of force was necessary. The films should be able to resist this mechanical stress even when exposed to greater traction so only the adhesion to the hardened resin could be determined. For this reason, the films selected were also relatively thick (100 μm).

It must be pointed out here that, needless to say, films without additional polymers such as polyamide or EVOH also have an outstanding adhesion to the cured resin when POP is used in the layer to be bonded with the resin. Example B15 shows this.

Here, the better resin adhesion effect ensues not only with a mixture of PE with POP, but also in a polypropylene (PP) with POP mixture. This follows from example 16 (3-layer film).

Thus, in principle, any other polymer can also be combined with POP to attain better adhesion to a film on which a resin is being cured.

In example B17, a polyolefin elastomer (POE) was used instead of a POP with Engage 8450. Also, the use of such material leads to a better adhesion of the film with the resin to be hardened. However, the effect is not as pronounced here as when a POP is employed, as demonstrated by the comparison of example 17 with the otherwise analogous film from example B1.

Last but not least, the film from example 18 showed a particularly good bond of the external side (1) with the external side (5) (which corresponds to the overlapping areas 9 in FIG. 2) namely already at a temperature of 80° C. The resin adhesion of the external side (1) is here likewise very good. This film is therefore ideally suitable for the spiral wrapping of the resin layer of a tube liners, as it has a particularly high imperviousness owing to the very good bonding of the overlapping edges.

Modifications and variations can be made to the embodiments illustrated or described herein without departing from the scope and spirit of the invention as set forth in the appended claims.

1-16. (canceled)

17. A film for the permanent, solid bonding with a resin after hardening of the resin, the film being particularly useful as a component of a tube liner in non-disruptive sewage pipe renovation, the film comprising at least a first layer that contains at least one polyolefin plastomer (POP) or one polyolefin elastomer (POE) capable of bringing about a permanent, direct adhesion of the resin to the first layer during a course of resin hardening.

18. The film as in claim 17, wherein the first layer contains the POP or POE in a proportion of more than 50% by weight.

19. The film as in claim 18, wherein the first layer or a different second layer contains an additional polymer from the following group:
Olefin homo- or copolymers, especially polyethylene (PE) or polypropylene (PP);
Polyamides (PA);
Amorphous thermoplasts such as polystyrene (PS) and polyvinyl chloride (PVC);
Polyesters, preferably polyethylene terephthalate (PET);
Polyurethanes;
Acryl ester polymers and copolymers;
Styrene acrylonitriles;
Polyvinyl esters such as polyvinyl acetate;
Polyvinyl acetals;
Polyvinyl alcohols;
Polyethers;
Polycarbonates
Polyhydroxy alcanoates;
Polysaccharides, cellulose, starch;
Copolymers of the compounds listed above.

20. The film as in claim 17, wherein a side of the film intended for application of the resin is pre-treated through corona, plasma or flame pre-treatment to increase surface tension.

21. The film as in claim 17, wherein the film is permeable to UV light to an extent such that UV light can pass through and cure the resin applied on the.

22. The film as in claim 17, further comprising one or a combination of: (1) an autonomous barrier layer, such as polyamide (PA) impervious to monomers, such as styrene; (2) a gas barrier layer, such as a layer containing up to 100% by weight of EVOH; or (3) a water vapor barrier layer with cyclic olefin copolymer (COC).

23. The film as in claim 17, further comprising an autonomous layer that contains more than 50% by weight of a thermoplastic olefin homo- or copolymer.

24. The film as in claim 17, wherein the first layer is intended for application of the resin thereon and is activated in such a way below a temperature of 130° C. that the resin bonds directly with the first layer.

25. The film as in claim 17, wherein the first layer is the resin-adhering layer, the film further comprising an external layer facing away from the first layer, the external layer having more than 50% by weight of polyolefin homo- or copolymer and a melting point between 50° C. and 130° C. obtained by adding one or more of the following compounds to the external layer:
additional polyolefin homo- or copolymers;
Polyvinyl acetate homo- or copolymers;
(Meth)acrylic acid ester homo- or copolymers;
Polyethers;
Ionomers;
Polyvinyl acetals;
Polyurethanes;
Copolymers of the compounds listed above such as ethylene vinyl acetate copolymers (EVA or EVAc).

26. The film as in claim 17, wherein the first layer is intended for application of the resin and has a thickness of 1 to 500 μm.

27. The film as in claim 26, wherein the film has an overall thickness of 20 to 1000 μm.

28. An arrangement with the film according to claim 17, and further comprising a resin with or within a carrier material layer applied to the first layer, and a second film according to claim 17 applied to an opposite side of the resin and carrier material layer such that the first layer of the second film is applied to resin and carrier material layer.

29. The arrangement as in claim 28, whereby the resin is in an unhardened state, and when hardened, the resin directly and firmly adheres to the first layer containing the POP or POE in each of the films.

30. A tube liner for use in non-disruptive sewage pipe renovation, the tube liner having a film according to claim 17.

31. The tube liner as in claim 30, wherein the tube liner is constructed as one of the following arrangements:
(1) the film according to claim 17 is an inner tube film wherein the first layer containing the POP or POE is at a side of the inner tube film closer to a pipe wall of the sewage pipe and has the resin applied thereto, wherein the inner tube film remains in the sewage pipe after the resin has hardened, and wherein the inner tube film is at least partially permeable to UV radiation;
(2) the film according to claim 17 is an external film that surrounds the resin from outside and absorbs or reflects UV radiation;
(3) the film according to claim 17 is an inner external film in the form of a flat film wound spirally and with overlapping areas around the resin, wherein the first layer containing the POP or POE thermally bonds to the resin and the overlapping areas bond adhesively through melting of an external layer facing away from the resin at a temperature between 50° C. and 130° C. during course of the exothermic hardening of the resin;
(4) the film according to claim 17 is a preliner placed tightly against a pipe wall of the sewage pipe;
(5) the film according to claim 17 is a sliding film placed tightly against a lower area of a pip wall of the sewage pipe;
(6) the film according to claim 17 is a calibration hose; or
(7) the film according to claim 17 is a protective film placed tightly against the resin layer of the tube liner.

32. The film according to claim 17, wherein the film is used as one of the following:
plastic strengthened with glass fiber applications
ship building applications;
aircraft construction application;
laminate manufacturing with hardening resins;
as inner or outer surface finish of containers and tanks formed with resins and carrier materials; and
in the surface finish of resins.
